(19) United States
(12) Patent Application Publication
(10) Pub. No.: US 2003/0220831 A1
(43) Pub. Date: Nov. 27, 2003

(54) System and method of collecting surveys remotely

(75) Inventor: William Y. Son, Poway, CA (US)

Correspondence Address: FOLEY & LARDNER, 402 WEST BROADWAY, 23RD FLOOR, SAN DIEGO, CA, 92101

(73) Assignee: LifeVine, Inc.

(21) Appl. No.: 10/154,050

(22) Filed: May 21, 2002

(51) Int. Cl. G06F 17/60

(52) U.S. Cl. 705/10; 705/2

(57) ABSTRACT

According to the disclosed embodiments of the present invention, a system and method of collecting surveys remotely for survey requesting entities, such as pharmaceutical companies and others, include generating survey request messages via a plurality of two-way communication devices periodically to request survey information therefrom. Survey response messages are then uploaded from the communication devices in response to the survey request messages. The response messages are then stored, and may then be distributed to the survey requesting entities.

### BACKGROUND OF THE INVENTION

1. Field of the Invention

The present invention relates in general to a system and method of collecting surveys remotely. It more particularly relates to such a system and method, which greatly facilitate, in a reliable and efficient manner, the collection of surveys, such as clinical trial surveys as well as others.

2. Related Art

The conducting of surveys has been employed for gathering data and other information concerning new products and services. Surveys have been used for a variety of purposes. For example, the pharmaceutical industry employs surveys for clinical trials, marketing organizations conduct surveys regarding consumer preferences for merchandise, and others.

In the pharmaceutical industry, the survey requirements are, of course, more stringent when information is being gathered on the efficacy of new drugs, therapies and devices.

For many years, clinical researchers collecting surveys for clinical trials have utilized paper diaries, which have been distributed to subjects engaged in the study to enable them to provide written records. In this regard, as a part of clinical trials of new drugs, therapies or devices, the subjects undergoing treatment have been required to record, on a periodic basis, such as daily, the results of the treatment. For example, the study protocol may require the subject undergoing treatment to record in his or her paper diary their current physical condition such as the degree of pain being experienced.

When the subjects of the study have been asked to hand-write information in a diary, problems with subject acceptance and compliance have been experienced. For example, subjects may record the information after the fact, and thus the information may be inaccurate or incomplete.

The use of hand-recorded paper diaries frequently result in poor or undesirable data quality. The information contained in the written diary must be transcribed, coded and entered into a computerized database. Thus, incorrect information can be inadvertently entered into the system. As a result of these inaccuracies and poor quality data, there can be unwanted delays in the data lock for the system due to the queries necessary to resolve issues regarding the entered data.

When the subjects deliver their handwritten diaries to the requesting entity such as the pharmaceutical company, clinical research office or site, personnel enter the data from the diaries into computer systems. Frequently, as a result of poor handwriting or missing entries, follow-up queries must be made of the subjects to ensure the accuracy of the data before the data entry is locked. Such queries produce unwarranted and undesirable delays.

Furthermore, it has been determined that the subjects are not always compliant when using paper diaries. It has been discovered and documented that subjects sometimes horde paper diary sheets and complete them in batches. This sometimes leads to falsification of the diary entries.

In an attempt to overcome these shortcomings, electronic diaries are now being employed. For example, reference may be made to an article entitled ELECTRONIC DIARIES/APPLICATIONS AND WHAT WORKS IN THE FIELD, Applied Clinical Trials, April, 2002, which is incorporated herein by reference. In this regard, personal digital assistants (PDAs) have been employed by the subjects to record survey information electronically. To upload the information to the computer systems, the PDAs have been docked in personal computers.

While such techniques have resulted in improving the data locking time as compared to handwritten paper diaries requiring transcription, the electronic diaries have not always proven satisfactory, since the uploading of the data was frequently not done on a regular basis in an entirely satisfactory manner. Thus, delays have still been problematical. Also, the subjects can still enter data retrospectively. Therefore, the problems of inaccurate and falsified data continue to be a problem for some applications.

While the subjects were able to use an electronic diary to record the information to be collected, the subjects have sometimes opted to upload the information at their convenience at a later date, thereby resulting in the unwanted delays. Also, the batching of entries are still possible even with the electronic devices.

Thus, the problems of inaccurate and false entries are still possible even though, for some purposes, the electronic diaries are an improvement over handwritten paper diaries. Furthermore, the delays in uploading the data continue to be a serious problem. Delays in gathering the survey information can be extremely costly to the pharmaceutical companies, often costing many millions of dollars per day. Also, even more importantly, the availability of life saving treatments to those in need are delayed

### BRIEF DESCRIPTION OF THE DRAWINGS

The following is a brief description of the drawings:

FIG. 1 is a block diagram of a survey collection system, which is constructed in accordance with an embodiment of the present invention;

FIGS. 2 and 3 are screen shots of displays for the system of FIG. 1;

FIG. 4 is a flow chart diagram of a method according to an embodiment of the invention of the system of FIG. 1;

FIGS. 5-9 are face views of a transceiver illustrating different screen shots of displays therefor; and

FIG. 10 is a flow chart diagram useful in understanding the operation of the system of FIG. 1.

### DESCRIPTION OF CERTAIN EMBODIMENTS OF THE INVENTION

According to the disclosed embodiments of the present invention, a system and method of collecting surveys remotely for survey requesting entities, such as pharmaceutical companies and others, include generating survey request messages via a plurality of two-way communication devices periodically to request survey information therefrom. Survey response messages are then uploaded from the communication devices in response to the survey request messages. The response messages are then stored, and may then be distributed to the survey requesting entities.

Survey protocols are generated, and then stored for later use. The protocols are downloaded to the communication devices to enable them to be programmed with the desired survey protocol.

Thus, in accordance with the disclosed embodiments of the present invention, the subjects of the survey receive survey request messages via their two-way communication devices to remind them to enter current information according to the survey protocol. The subjects are then prompted to respond to the survey request in the form of questions, and then are able to conveniently enter their responses, which are uploaded in real time with time stamp information for distribution to the requesting entities.

Therefore, inaccuracies and delays are greatly reduced or minimized, since the responses are entered conveniently into communication devices in response to request messages. Due to the convenience of the system, the subjects are thus encouraged to comply with the survey protocols.

Additionally, a new protocol can quickly and easily be implemented. For example, once a subject has completed the survey, his or her communication device can then be readily reprogrammed for another survey by downloading the next protocol via the two-way communication link. Additionally, survey protocols can be modified, or new ones created and implemented quickly and efficiently by downloading the survey protocol programs to the communication devices.

The following detailed description is organized according to the following outline:

A) General System Description

B) General Method Description

C) Survey Generation

D) Survey Execution

### A) GENERAL SYSTEM DESCRIPTION

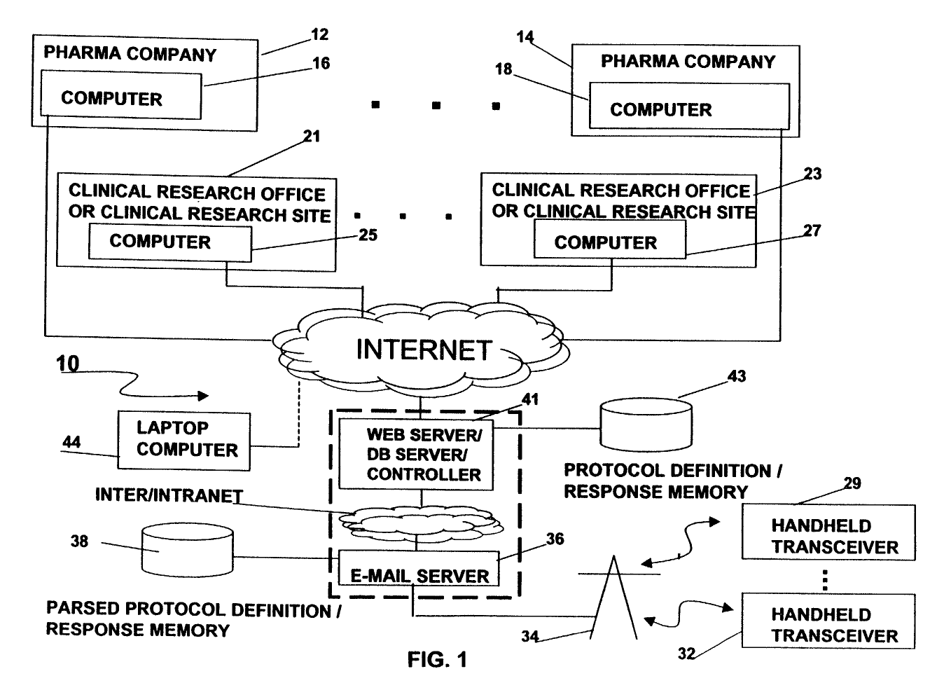

Referring now to the drawings, and more particularly to FIG. 1, there is shown a survey collecting system 10, which is constructed in accordance with a preferred embodiment of the present invention. The system 10 is adapted to collect surveys remotely for a group of survey requesting entities such as pharmaceutical companies 12 and 14 having respective computers 16 and 18. While it is to be understood that the system and method of the embodiments of the present invention may be used for a variety of different surveys, the preferred embodiment relate to the collection of survey information for clinical trials. However, it is to be clearly understood that the system and method of the disclosed embodiments of the invention may be used for other types and kinds of surveys, such as marketing surveys for goods and services, as well as others. Thus, the system and method of the disclosed embodiments of the present invention are described herein in connection with clinical trials.

As shown in FIG. 1, clinical research offices (CROs) or clinical research sites (CRSs) 21 and 23 employing respective computers 25 and 27 employ personnel to collect and validate the data received on a real time basis by the system 10 as hereinafter described in greater detail. In this regard, the system 10 includes a group of two-way communication devices in the form of hand-held transceivers such as transceivers 29 and 32 (FIGS. 1, 5-8) adapted to be used by the subjects of the survey.

According to the preferred embodiment of the present invention, the hand-held transceivers are each in the form of a two-way wireless pager device which communicates by sending and receiving electronic mail (e-mail) messages in a wireless manner via a wireless base station 34 to enable the hand-held transceivers 29 and 32 to communicate with an e-mail server 36. A memory 38 stores parsed protocol request messages and response messages received and sent respectively via the hand-held transceivers 29 and 32. In this regard, the e-mail messages sent via the e-mail server 36 to the hand-held transceivers, as well as the response messages sent from the hand-held transceivers to the e-mail server 36, are parsed or stripped of the conventional e-mail data, such as the names of the people who sent and received the message as well as the subject information. It will become apparent to those skilled in the art that the messages may also be communicated utilizing other techniques such as packet data and other communication systems.

A server 41 communicates with the e-mail server 36 via a suitable network such as the internet, an intranet or locally via wire or other communications to distribute the data available to the pharmaceutical company computers 16 and 18 and the CRO computers 25 and 27 via the internet. In this regard, the survey information uploaded from the transceivers is posted by the web server 41 for retrieval by the computers 16, 18, 25 and 27. A memory 43 stores the survey protocol. A laptop or other computer 44 is used to help generate the protocol surveys, and can be transported to the pharmaceutical companies and also to the CROs or CRSs to help create or modify protocols. After generating the protocol survey, a copy of it is sent to the server 41 for storage in the memory 43. Thereafter, the survey protocol and other controls are downloaded remotely to the selected transceivers which are available for use.

### B) GENERAL METHOD DESCRIPTION

In use, according to the disclosed embodiment of a method of the present invention, the laptop computer 44 retrieves protocol definitions stored in the memory 43 to generate a new protocol under the control of the laptop computer 44, or modifies an existing protocol, is hereinafter described in greater detail. The new protocol is then downloaded from the laptop computer 44 by sending an e-mail message either through the internet, intranet or locally, to the e-mail server 36, which stores the new protocol in the memory 38 and forwards a copy of the protocol message to the memory 43. Upon initiating a new protocol download procedure the web server and database server/controller 41 initiates the download sequence by accessing the protocol definition/response memory 43. The new protocol is then retrieved from memory 43 and is formatted by the e-mail server 36 to be transmitted via wireless base station 34 to the appropriate one of the hand-held transceivers such as the transceiver 29. The e-mail message containing the new survey protocol is then received and stored in the transceiver 29 and is used to program its operation relating to the new survey.

Thereafter, for example, a person (not shown), who is a subject of the survey and who uses the transceiver 29 receives survey request messages initiated by the transceiver 29. For example, the downloaded protocol survey stored in the transceiver 29 generates the request messages in response to the user entering information regarding a current event such as the taking of a medication, or a timed entry, such as a request message sent after a predetermined time delay interval, such as requesting whether the subject is experiencing a stomach pain. This request message received by the transceiver 29 typically reminds the subject to record current information regarding the survey by responding to a question contained in the message. In this regard, a message is displayed by the hand-held transceiver 29 requesting certain information regarding the current status of the subject. For example, it may prompt the subject to rate the severity of his or her pain intensity currently being experienced after taking a medication. The user of the transceiver 29 then enters a response message into the transceiver 29. For example, the user may provide a response message containing a quantified indication of the amount of the intensity of the pain currently being experienced.

Upon indicating whether the current sets of questions have been completed or not, the response message is then uploaded from the transceiver 29 via the base station 34 to the e-mail server 36 and then to the web server 41 for distribution to the pharmaceutical company computers and the CRO and CRS computers. The response message sent to the server 41 is stored in the memory 43. This survey data response information can then be retrieved in real time via the internet or other network to a survey requesting computer such as the computer 25 of the appropriate CRO or CRS such as the office or site 21 associated with the user of the transceiver 29. The information can also be distributed to the computer, such as a computer 16 of the pharmaceutical company such as company 12. In this manner, any one of the survey requesting computers such as the computers 16, 18, 25 and 27 can access the survey response information at any time, from anywhere where internet or remote access is possible, from the web server 41.

### C) SURVEY GENERATION

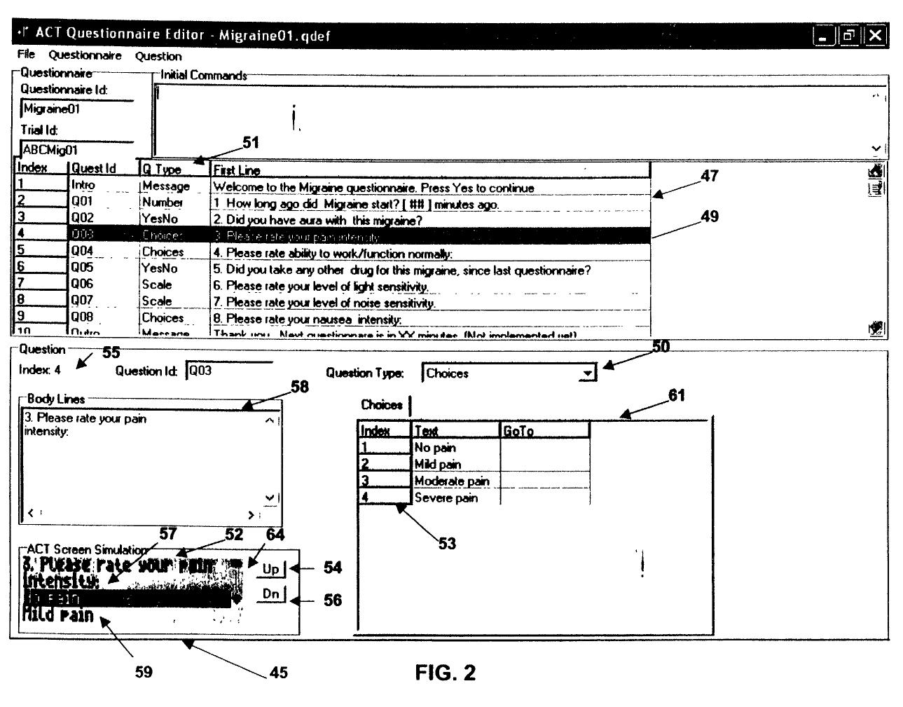

Referring now to FIG. 2 of the drawings, the generation of a new survey will now be described. It is to be understood that either a new survey can be designed or an old survey can be modified utilizing the following technique. The laptop computer 44 (FIG. 1) is used to execute a protocol definition generator module. In so doing, the laptop computer 44 utilizes a questionnaire editor screen 45 to assist in the creation or modification of the new survey.

A protocol selection menu 47 of protocol definitions including messages and questions for the subject. For example, as indicated at 49, one question may be “Please rate your pain intensity:”. This question falls in the question type category as a “Choices” as indicated in the question type window 50, as well as under the Q Type column 51 of the window 47, indicating that this type of question prompts the subject to enter one of a selection of choices presented to the subject. The window 50 can be used to modify the question type such as from “Choices” to “Scale”.

When the question is highlighted and selected at 49, a screen simulation window 52 displays the question 57 corresponding to the selected question 49, together with the responses/choices at 59 to be selected by the subject. A pair of scroll buttons 54 and 56 are positioned opposite to a pair of scroll button 64 which would be used to facilitate the selection of the appropriate response by the subject.

As a result, the person creating the new survey can see illustrated in the screen simulation window 52 how the subject would view the display on his or her transceiver. A body lines window 58 also displays the question under consideration, and can be used for editing it for a particular application as desired. Upon editing the body lines information of the window 58, the edited version of the question appears in the screen simulation window 52 so that the designer of the survey can determine if the modified question properly fits in the display for the transceivers and is appropriate for the survey.

A choices window 61 lists all of the possible choices for the selected question 49. In this regard, the selected question 49 has four choices indicating four separate levels of subjective pain which could be experienced by the subject. If the number of choices is desired to be adjusted such as by increasing or decreasing the number of choices, the designer uses the laptop computer 44 to right click on any one of the numbers 1-4 in the index column generally indicated at 53 to cause a drop down menu (not shown) to allow the adjustment of the number of indexes. In this manner, the designer of the survey can then increment or decrement the number of choices for the subjects as desired. Also, if an additional choice is added, the user of the laptop computer 44 can enter text to identify the new selection. Also, the prior definitions or “text” for the choices can also be edited by using a left click function on the displayed list of responses.

Additionally if one wishes to insert or delete an entry from window 47, the protocol definition generator screen 45, indicates such insertion or deletion of entries by either incrementing or decrementing the member in the index window 55. Then, a new number appears in an index window 55. In this regard, the number “4” could, for example, be changed to a new number such as a number “5”.

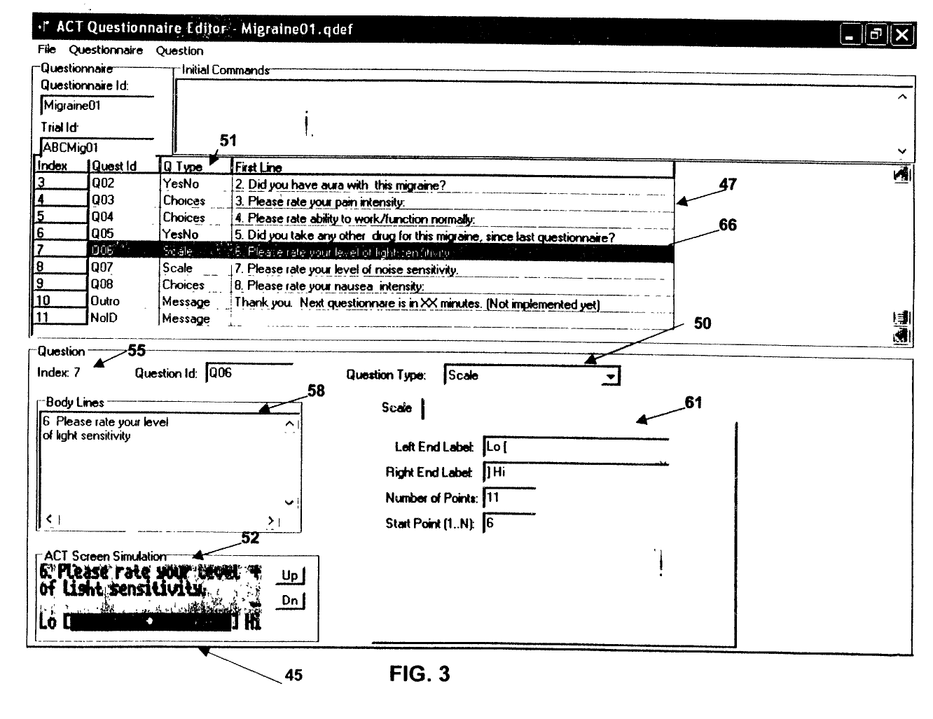

Referring now to FIG. 3, when a different protocol definition is selected, another line on the protocol selection menu screen 47 is selected, such as the line 66 indicating a question “Please rate your level of light sensitivity.” This selection is a scale type as indicated under the type column 51. Thus, the word “Scale” appears in the question type screen 50. The new question also appears in the body lines screen 58 and in the screen simulation 52.

Upon completion of the creation or modification of the new survey protocol, once completed, it is sent to the web server 41 for storage in the memory 43. The new survey protocol can be checked for accuracy and conformity by utilizing a simulator program module which resides in computer 44. The simulator program prompts the user to select the new protocol definition file, and then creates images of the transceiver into the laptop screen to confirm the functionality of the new protocol definition file. During the simulation process, modifications can be made by using the protocol generator. Once confirmed, the confirmed file is stored and a downloading procedure commences to program the transceivers.

For additional confirmation of the new protocol prior to programming the transceivers, the protocol can be downloaded to a transceiver which is physically located at the location of the laptop computer 44 so that the person designing the protocol can confirm that the downloading of the protocol can be successfully accomplished to the transceivers. Once confirmed, the new protocol file is downloaded to all of the appropriate transceivers utilized for executing the survey. Since the internet or other networks may be employed, the new protocol can be conveniently created or modified remotely and downloaded to a large number of transceivers located in a wide variety of different geographical locations in a very quick and efficient manner. Thus, the new protocol, or a modified one, can be implemented in a very rapid manner and distributed to all of the appropriate transceivers for immediate service in the taking of the new survey. Such fast survey implementation also helps reduce the unwanted delays in completing the survey itself.

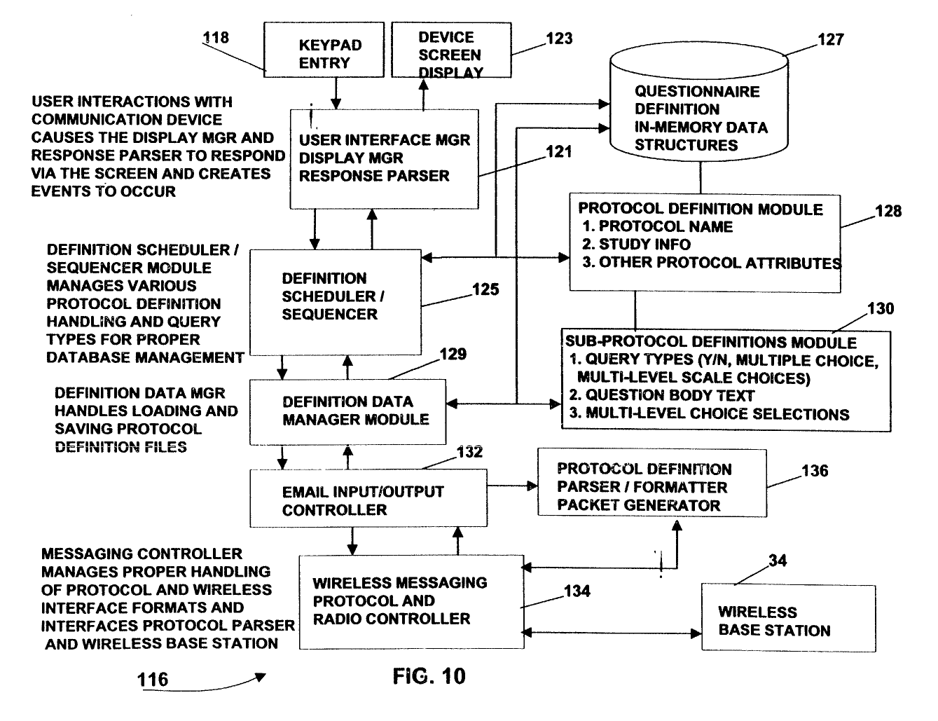

The simulator program is similar to the definition executor program (FIG. 10) which is stored in each transceiver. The simulator program has all of the functionality of the definition executor program, but enables it to be used on a laptop or other personal computer, as well as being adopted to work with selected one or more of the protocol definition files.

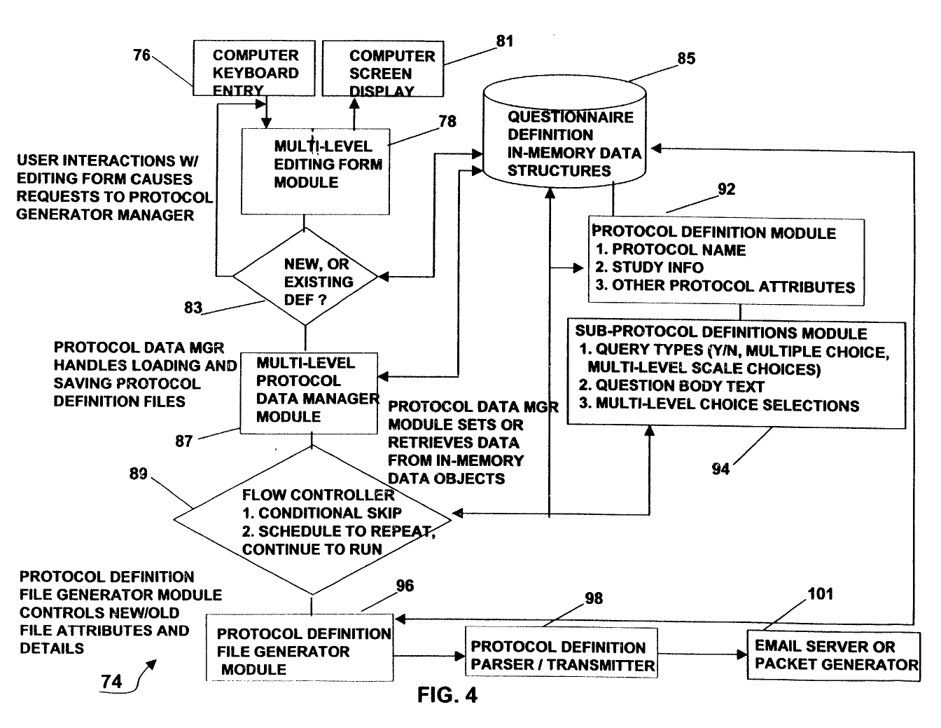

Referring now to FIG. 4, the method of creating the new protocol will now be considered in greater detail. In order to help accomplish the creation of a new protocol, or the modification of an old one, a protocol definition generator module 74 is employed as illustrated diagrammatically in FIG. 4. As indicated in box 76, a keyboard entry is accomplished at the laptop computer 44 to initiate the operation. A multi-level editing form module is retrieved at 78. The computer screen display at 81 is then presented to the designer of the new protocol at the laptop computer 44 as indicated in FIG. 2 and FIG. 3.

Thereafter, as indicated in 83, it is determined whether the protocol to be generated is a new or existing definition. If a new protocol definition is to be generated, the user interactions with the editing form causes the request to the protocol generator manager to return back to the multi-level editing form module as indicated at 78 to create the new or modified protocol as previously indicated in connection with the description of FIG. 2 and FIG. 3 of the drawings.

As these new definitions are being created, they are stored in the memory of the laptop computer 44 as indicated in box 85. Similarly, if the protocol is a modification of an existing protocol, the existing definitions are retrieved from the questionnaire definition in memory data structures at 85 stored in the laptop computer 44.

This operation is executed under the control of the protocol data manager module which handles the loading and saving of protocol definition files as indicated in box 87. The protocol data manager module sets or retrieves data from in-memory data objects. As indicated in box 89, a flow controller determines whether a conditional skip or a schedule to repeat, continue to run, is to be executed. The protocol definition file generator module controls new/old file attributes and details in accordance with the execution of the protocol definition generator 74. As indicated in box 92, the protocol definition module provides the protocol name, the study information and other protocol attributes. As indicated in box 94, a sub-protocol definitions module facilitates the providing of the query types such as yes and no responses, multiple choice, multi-level scale choices and others. Also, it facilitates the providing of any question body text, as well as multi-level choice selections.

As a result, as indicated in box 96, a protocol definition file generator module responding to the memory, provides the protocol definition parser and transmitter as indicated at 98 to provide the e-mail server information at box 101, or alternatively, a packet generator or other generator if an alternate transmission scheme is employed.

### D) SURVEY EXECUTION

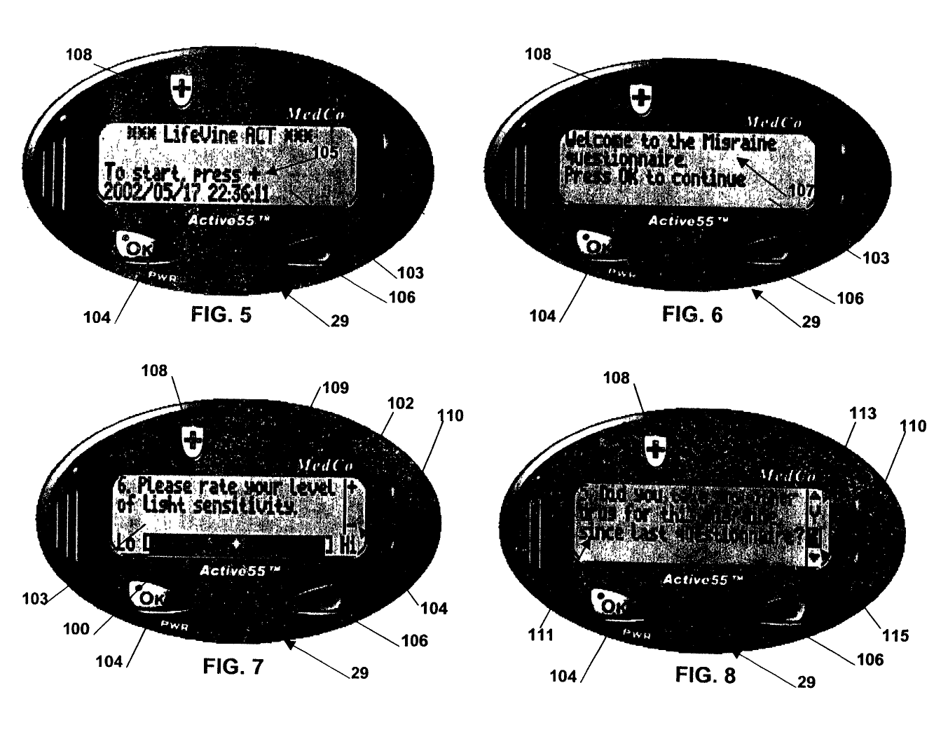

Referring now to FIGS. 5, 6, 7 and 8, there is shown the transceiver 29 in various modes of its operation. As indicated in FIG. 5, the transceiver 29 includes a display screen 103 for displaying survey request information such as the message 105 indicating “To start, press +”.

A dedicated + button 108 can be actuated by the subject to invoke the start of a survey programmed in response to the message 105. In this regard, the downloaded protocol stored in the transceiver 29 then responds to the pushing of the button 108 to initiate the survey request messages for the subject.

An OK button 104 is used for responding to certain question messages displayed by the screen 103. Also, the button 104 serves as a power ON button so that when it is pushed and held in the depressed position for a sufficiently long period of time, the transceiver 29 is activated.

A dedicated return button 106, when actuated, causes a previous screen to be re-displayed. It may also be used for other functions as well.

As shown in FIG. 6, there is shown another message 107 which designates the questionnaire as being one for migraine headaches by stating “Welcome to the Migraine questionnaire”. Assume, for example, that this message was displayed in response to the subject pressing the + button 108 as indicated in FIG. 5. The message also includes the request “Press OK to continue”. When the OK button 104 is pressed in response to the request 107, the next message produced by the stored protocol is displayed at the screen 103 as indicated in FIG. 7.

As shown in FIG. 7, another message 109 is displayed indicating “6. Please rate your level of light sensitivity.” as indicated in 109 on the screen 103. A scale indicated generally at 100 is displayed on the screen 103 below the message 109 to help the subject to indicate the level of light sensitivity as prompted by the survey request 109. The response is entered by means of a toggle switch 110 indicating either a plus or a minus direction of the scale. As indicated in FIG. 7, a + indicia 102 and a − indicia 104 are displayed on the screen 103 adjacent to a toggle switch 110 to direct the subject as to the intensity being higher or lower than the indicated mid-level intensity on the scale 100. Thus, the dedicated toggle switch 110 can be activated in either the + or in the − direction as indicated in the directions 102 and 104.

Referring now to FIG. 8, there is shown a subsequent message “5. Did you take any other drug for this migraine since last questionnaire?” as indicated at 111. A Y indicia 113 and N indicia 115 are displayed, one above the other, adjacent to the toggle switch 110 to indicate either a YES or a NO indication in response to the request 111 when actuated accordingly.

Thus, messages can be displayed by the screen 103 of the transceiver 29 either in response to the subject pressing the + button 108, or a message can be generated after a predetermined time delay interval following a preceding message. If a user fails to respond to a response message, a signal such as a beeping signal is generated by the transceiver 29 to attract the attention of the subject to respond to the request message. If the responses are complete, or if no response is received after a predetermined number of the reminder beeps are sent, then the collected responses, whether incomplete or not, are sent via e-mail to the web server 41 for storage in the memory 43 so that the responses can be made available to the pharmaceutical company computers and/or the CRO and CRS computers.

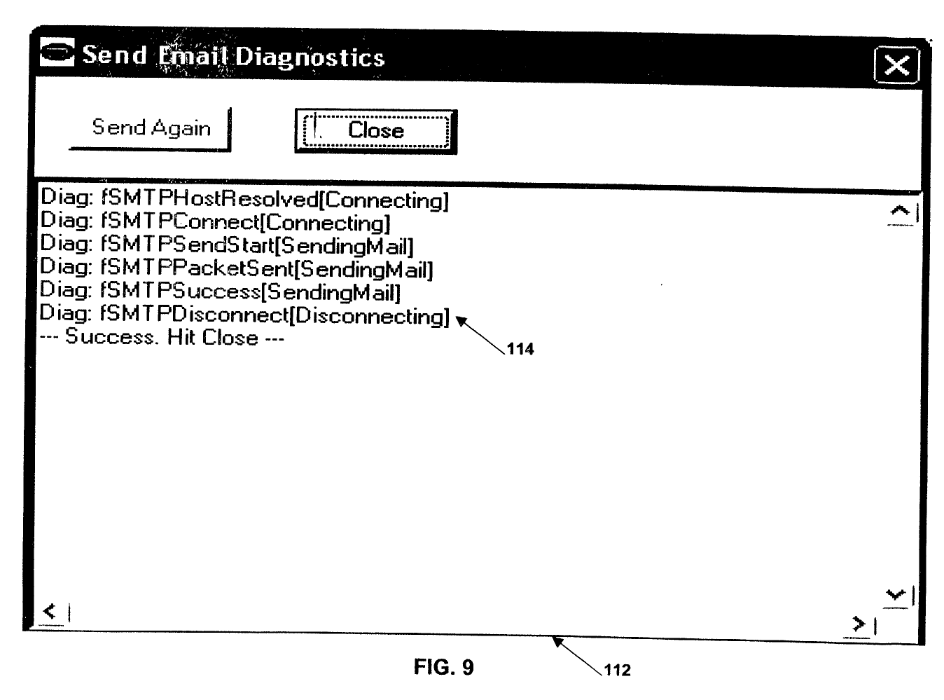

As shown in FIG. 9, a sent e-mail diagnostic screen 112 displays sent e-mail diagnostics. In this regard, the sent e-mail can be tracked and monitored appropriately.

Referring now to FIG. 10, the execution of the survey protocol will now be described in greater detail. A definition executor module 116 controls the operation of sending e-mail messages from the transceiver and other control functions. In response to a key pad entry 118, such user interactions with the transceiver cause a display manager and response parser module to respond via the screen and creates events to occur as indicated at 121 and 123.

A definition scheduler and sequencer module manages various protocol definition handling inquiry types for proper data base management as indicated 125. The managing of the various protocol definition inquiry types cause interaction with the memory as indicated in 125 and 127. A definition data manager module handles loading and saving protocol definition files as indicated at 129 for interaction with the memory as indicated at 127.

As indicated at box 128, a protocol definition module helps provide the protocol name, study information and other protocol attributes. Also, a sub-protocol definitions module helps provide the query types such as the yes/no, multiple choice, multi-level scale choices and others. Also, it helps provide the question body text, and the multi-level choice selections.

An e-mail input/output controller is employed as indicated at 132, whereby a messaging controller module manages proper handling of the protocol and wireless interface formats and interfaces protocol parser and wireless bay station processing as indicated at 134. The protocol definition parser formatter package generator is employed as indicated at 136. The wireless bay station 34 is then utilized to transmit the e-mail message to the server 41.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A method of collecting surveys remotely for survey requesting entities, comprising:
generating survey request messages via a plurality of two-way communication devices periodically to request survey information therefrom;
uploading survey response messages from the two-way communication devices in response to the generated messages;
storing the received survey response messages; and
distributing the stored received survey response messages to the survey requesting entities.

2. A method according to claim 1, further including generating a survey protocol for said survey request messages, and storing the generated survey protocol.

3. A method according to claim 2, further including storing a group of survey definition messages, and selecting certain ones of said group of survey definition messages to generate said survey protocol.

4. A method according to claim 3, further including executing the sending of survey request messages.

5. A method according to claim 4, wherein said generating a survey protocol includes storing a protocol definition generator program.

6. A method according to claim 5, wherein said executing the sending of survey request messages includes storing survey executor programs in the two-way communication devices.

7. A method according to claim 5, wherein said generating a survey protocol includes displaying simulated survey request messages.

8. A system for collecting surveys remotely for survey requesting entities, comprising:
a plurality of two-way communication devices;
means for generating survey request messages via said plurality of two-way communication devices periodically to request survey information therefrom;
means for uploading survey response messages from the two-way communication devices in response to the generated messages;
means for storing the received survey response messages; and
means for distributing the stored received survey response messages to the survey requesting entities.

9. A system, according to claim 8, further including means for generating a survey protocol for said survey request messages, and storing the generated survey protocol.

10. A system according to claim 9, further including means for storing a group of survey definition messages, and selecting certain ones of said group of survey definition messages to generate said survey protocol.

11. A system according to claim 10, further including means for executing the sending of survey request messages.

12. A system according to claim 11, wherein said means for generating a survey protocol includes means for storing a protocol definition generator program.

13. A system according to claim 12, wherein said means for executing the generating of survey messages includes means for storing survey executor programs in said communication devices.

14. A system according to claim 12, wherein said means for generating a survey protocol includes means for displaying simulated survey request messages.

15. A system for collecting surveys remotely for survey requesting entities, comprising:
a plurality of two-way communication devices;
a first circuit for generating survey request messages via said plurality of two-way communication devices periodically to request survey information therefrom;
a second circuit for uploading survey response messages from the two-way communication devices in response to the generated messages;
a third circuit for storing the received survey response messages; and
a fourth circuit for distributing the stored received survey response messages to the survey requesting entities.

16. A system according to claim 8, further including a fifth circuit for generating a survey protocol for said survey request messages, and a sixth circuit for storing the generated survey protocol.

17. A system according to claim 9, further including a seventh circuit for storing a group of survey definition messages, and an eighth circuit for selecting certain ones of said group of survey definition messages to generate said survey protocol.

18. A system according to claim 10, further including a ninth circuit for executing the generating of survey request messages.

19. A system according to claim 11, wherein said fifth circuit for generating a survey protocol includes a tenth for storing a protocol definition generator program.

20. A system according to claim 12, wherein said ninth circuit for executing the generating of survey messages includes an eleventh circuit for storing survey executor programs in said communication devices.

21. A system according to claim 12, wherein said fifth circuit for generating a survey protocol includes a twelfth circuit for displaying simulated survey request messages.
